(19) United States
(12) Patent Application Publication
(10) Pub. No.: US 2026/0039994 A1
(43) Pub. Date: Feb. 5, 2026

(54) ASYMMETRIC SPEAKER SYSTEM

(71) Applicant: Sang Hoon Park, Icheon-si (KR)

(72) Inventor: Sang Hoon Park, Icheon-si (KR)

(21) Appl. No.: 19/355,275

(22) Filed: Oct. 10, 2025

Related U.S. Application Data
(63) Continuation of application No. PCT/KR2024/004630, filed on Apr. 8, 2024.

(30) Foreign Application Priority Data
Apr. 11, 2023 (KR) 10-2023-0047192

(51) Int. Cl. H04R 1/24; H04R 1/02; H04R 3/14; H04R 5/02

(52) U.S. Cl. CPC H04R 1/24; H04R 1/025; H04R 3/14; H04R 5/02

(57) ABSTRACT

The present invention relates to a speaker system, and relates to a speaker system in which two or more separated speaker units are arranged in enclosures to provide a sense of stereo sound, and the separated units area asymmetrically configured between speakers.

### CROSS-REFERENCE TO RELATED APPLICATION

This application is a Continuation of International Application No. PCT/KR2024/004630 filed Apr. 8, 2024, claiming priority based on Korean Patent Application No. 10-2023-0047192 filed Apr. 11, 2023, the disclosure of which is incorporated herein by reference in its entirety.

### BACKGROUND

### 1. Field of the Invention

The present invention relates to a speaker system, and more particularly, to a speaker system in which a sense of presence is improved by arranging a plurality of speaker units responsible for a high frequency, a middle frequency, and a low frequency or a high frequency and a middle-low frequency differently and asymmetrically in individual enclosures.

### 2. Discussion of Related Art

As is generally known, a speaker is an acoustic device and is a device that emits sound waves by converting an electrical signal input from an amplifier (AMP) into acoustic energy that may be heard by a human.

Based on this, in a stereo (dual channel or two-channel) speaker system according to the related art, to provide a sense of stereo presence to a listener, a left speaker and a right speaker that are symmetric to each other with respect to the listener are arranged at a predetermined angle.

This speaker arrangement method is currently the most commonly used method in installation of a high-fidelity (hi-fi) speaker.

However, in the stereo speaker system used in the speaker arrangement method, a left speaker unit and a right speaker unit are symmetric to each other, which are advantageous for forming a sweet spot, but a sense of presence of a sound field may be limited due to the symmetric structure.

There are several notable related arts for overcoming this limitation as follows.

First, in the case of PCT International Patent Application No. PCT/CA2012/000392, a relatively small speaker enclosure compared to the standard speaker enclosure is used. To this end, a size of a full range speaker unit is changed, and thus a middle-pitched range and a high-pitched range are separated from each other. However, since only one full-range unit is used, it is not enough to play various tones.

Second, U.S. Patent Registration No. 7,298,862 B2 relates to a speaker system installed on a mobile phone, and a port (ported cabinet or base-reflex; phase inversion) is selectively installed only in one speaker enclosure. Accordingly, an effect in which the low-pitched range is played well and the high-pitched range is suppressed is attempted, and the effect is relatively insignificant compared to PCT/CA2012/000392 in which a size of a speaker unit is changed to separate the middle-pitched range and the high-pitched range from each other.

### RELATED ART DOCUMENTS

### Patent Documents

(Patent Document 0001) Korean Patent No. 10-0636252 Space stereo sound generation method and device
(Patent Document 0002) Korean Patent No. 10-0739776 Stereoscopic sound generation method and device
(Patent Document 0003) Korean Patent No. 10-1355414 Audio signal processing device, audio signal processing method, and audio signal processing program
(Patent Document 0004) Korean Patent No. 10-1547639 Sound focusing device and method
(Patent Document 0005) Korean Patent Registration No. 10-1687085 System and method for improving stereo sound field in two-channel audio
(Patent Document 0006) Korean Patent No. 10-1768260 Optimum cancellation of crosstalk that is not spectrally uncolored for audio through speaker
(Patent Document 0007) Korean Patent Registration No. 10-2468272 Sound output device and control method thereof
(Patent Document 0008) PCT International Patent Application No. PCT/CA2012/000392 STEREO LOUDSPEAKER SYSTEM WITH ASYMMETRIC SPEAKER ENCLOSURES
(Patent Document 0009) U.S. Patent Registration No. 7,298,862 B2 Asymmetric loudspeaker enclosures with enhanced low frequency response

### Non-Patent Documents

(Non-Patent Document 0001) Griesinger, “Spaciousness and Envelopment in Musical Acoustics,” in 101st Convention of the AES, 1996.
(Non-Patent Document 0002) M. Morimoto, “The Role of Rear Loudspeakers in Spatial Impression,” in 103rd Convention of the AES, 1997; D.
(Non-Patent Document 0003) D. B. Ward and G. W. Elko, “Effect of loudspeaker position on the robustness of acoustic crosstalk cancellation,” IEEE Signal Process. Lett. 6, pp. 106-108, vol. 6, May 1999.
(Non-Patent Document 0004) K. Hamasaki, K. Hiyama, and R. Okumura, “The 22.2 Multichannel Sound System and Its Application,” in 118th Con-vention of the AES, 2005.
(Non-Patent Document 0005) Haruo Hamada, “High scene sense system by stereo speaker,” Journal of Video Information Media (Japan), 61 (5), 2007, pp. 629-637.
(Non-Patent Document 0006) K. S. Lee and S. P. Lee, “A real-time audio system for adjusting the sweet spot to the listener's position,” IEEE Trans. on Consumer Electronics, pp. 835-843, vol. 56, No. 2, May 2010.
(Non-Patent Document 0007) Y. Lacouture Parodi and P. Rubak, “Objective Evaluation of the Sweet Spot Size in Spatial Sound Reproduction Using Elevated Loudspeakers,” J. Acoust. Soc. Am., pp. 1045-1055, vol. 128, No. 3, September 2010.
(Non-Patent Document 0008) Lee Hee-jong, Seo Sang-won, Lee Myung-jin, Kim Yong-wan, “3D sound technology,” Software Technology Trends, vol. 2, no. 2, pp. 54-80, 1998.
(Non-Patent Document 0009) Boo Jeong-yong, Choi Soo-jin, Kim Ki-jun, Park Ho-jong, “Speaker-driving algorithm for the provision of optimum sweet spot,” Summer Conference of the Korea Broadcasting Engineering Association, pp. 46-49, June 2014.

### SUMMARY OF THE INVENTION

The present invention is directed to an asymmetric speaker system that improves a sense of presence of a stereo sound field by changing the number of driver units of individual speakers or asymmetrically arranging the driver units formed of different materials.

According to an aspect of the present invention, there is provided a speaker system in which asymmetric driver units are arranged, wherein a first speaker and a second speaker are arranged with respect to a listener, the first speaker and the second speaker are configured to have a predetermined angle with respect to the listener, a plurality of speaker driver units that emit a high-pitched sound, a medium-pitched sound, and a low-pitched sound are arranged in the first speaker, and a plurality of speaker driver units that emit a high-pitched sound and a middle-low-pitched sound are arranged in the second speaker.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front view of an asymmetric speaker system according to a first embodiment that is the present invention;

FIG. 2 is a front view of an asymmetric speaker system according to a second embodiment that is the present invention; and

FIG. 3 is a front view of an asymmetric speaker system according to a third embodiment that is the present invention.

### DETAILED DESCRIPTION OF EXEMPLARY EMBODIMENTS

In general, in a stereo speaker system, an area of a sweet spot is varied according to positions of a driving speaker and a listener, and furthermore, a sense of presence is reduced in a process of transmitting a signal from the speaker to the listener.

In this condition, in stereo signals emitted from left and right speakers together with signals input to left and right ears of the listener, crosstalk occurs in which the signal from the left speaker is transmitted to the right ear and the signal from the right speaker is transmitted to the left ear. Crosstalk cancellation technology has been developed to remove this phenomenon (D. B. Ward and G. W. Elko, “Effect of loudspeaker position on the robustness of acoustic crosstalk cancellation,” IEEE Signal Process. Lett. 6, pp. 106-108, vol. 6, May 1999. and K. S. Lee and S. P. Lee, “A real-time audio system for adjusting the sweet spot to the listener's position,” IEEE Trans. on Consumer Electronics, pp. 835-843, vol. 56, No. 2, May 2010).

In this way, an area in which sound waves from the left and right speakers are transmitted to the left and right ears of the listener through a signal from which crosstalk is canceled is called a sweet spot. However, the area of the sweet spot occurs only in a limited space according to arrangement of the driving speaker and the position of the listener. To improve this, a multi-channel speaker system using more speakers that are variously arranged has been proposed, but this inevitably causes discontinuous directionality or sound quality degradation.

Thus, the present inventor seeks a method for improving a sense of presence of a stereo sound field from the existing stereo speaker system. The starting point is “where is a space of the sweet spot in real life?” That is, where is a position of the sweet spot in which the listener may hear the best sound in a concert hall in which an actual performance takes place?

To narrow the scope, taking a classical performance as an example, the scale varies according to the type of performance, e.g., solo music, chamber music, or orchestral music. As a result, an optimum position also changes. Thus, a shape and size of the concert hall are reflected in sound design in consideration of characteristics suitable for a purpose of use in advance.

Even so, a crosstalk phenomenon that occurs during the performance cannot be completely prevented. That is, the crosstalk phenomenon in real life is spontaneous, and efforts have only been made to minimize the crosstalk phenomenon. The stereo speaker system is no exception.

Thus, the present inventor started to search for a method for improving a sense of presence of the stereo sound field while recognizing this phenomenon as a variable without trying to artificially cancel the crosstalk phenomenon.

In organizing an orchestra, a front part may be roughly divided into two parts centered on a conductor. On the left side, first violins and second violins are positioned in a stringed instrument part, and piccolos, flutes, and clarinets are positioned in a woodwind instrument part. On the right side, a viola, a cello, and a contra bass are positioned in a stringed instrument part, and an oboe, a bassoon, and a double bassoon are positioned in a woodwind instrument part. Further, a percussion part and a brass wind instrument part are separately positioned therebehind.

When historically looking at instrumentation, it is well-known that the instrumentation was initially simply centered on stringed instruments, but orchestral music instrumentation rapidly changed through the Classical period and underwent further changes from the Romantic period and into modern music.

Considering the orchestral music instrumentation, the present inventor further focused on a method of introducing this orchestral music instrumentation into the stereo speaker system.

In conclusion, it is natural that, based on the listener, the left speaker outputs a relatively high-pitched range, while the right speaker outputs a low-pitched range.

In order to achieve the above object, an exemplary first embodiment of the present invention is as follows.

As illustrated in FIG. 1, in a predetermined enclosure 10, a 1-inch beryllium tweeter 11 [manufacturer: Scanspeak, model name: D3004/6040-10; this order will be used hereinafter], a 3-inch silk dome mid-range 12 [Scanspeak, D7608/920010], and a 4.5-inch glass fiber dome midrange 13 [Scanspeak, 12W/8524G00] are sequentially arranged from an upper end on a left side.

On the other hand, a 1-inch silk dome tweeter 14 [Scanspeak, D2905/930000] and an 8-inch paper cone woofer 15 [Vifa, M21WJ-09-08] are arranged on a right side.

In this case, a beryllium tweeter having a resonance frequency of 450 Hz for a relatively high frequency output is disposed in the left speaker, while a silk dome tweeter having a resonance frequency of 650 Hz is disposed in the right speaker.

Further, a crossover of the left speaker is selected from a range of 2.5 kHz to 4.5 kHz, a crossover of the right speaker is selected from a range of 1.5 kHz to 3.5 kHz, and the left speaker has a higher frequency than the right speaker. In more detail, the left speaker has a higher crossover frequency than the right speaker by a range of 1 kHz to 1.5 kHz.

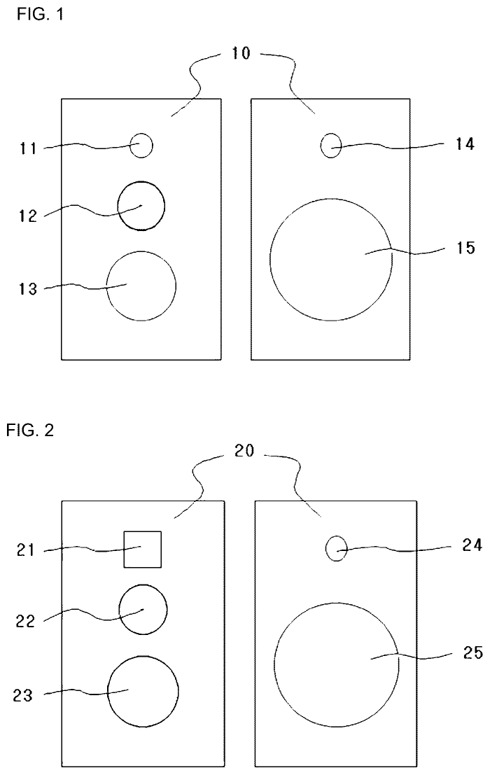

As a second embodiment obtained by applying the first embodiment, as illustrated in FIG. 2, in a predetermined enclosure 20, an aluminum ribbon tweeter 21 [AurumCantus, G2], a 3-inch silk dome midrange 22 [Scanspeak, D7608/920010], and a 6-inch leather synthetic midrange/woofer 23 [Sonodyne, Hummer625] are sequentially arranged from the upper end on the left side, and a 1-inch silk dome tweeter 24 [Scanspeak, D2905/970000] and an 8-inch paper cone woofer 25 [Vifa, M21WJ-09-08] are arranged on the right side.

Here, the crossovers of the left speaker and the right speaker follow the scope of the first embodiment.

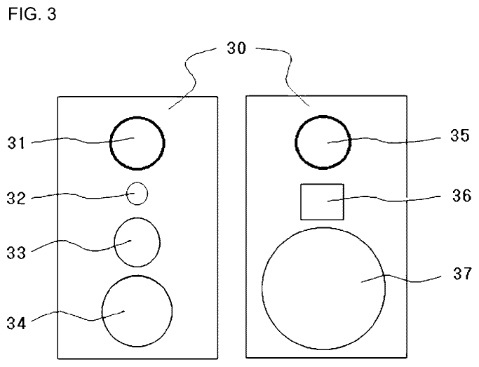

An exemplary third embodiment, as illustrated in FIG. 3, in a predetermined enclosure 30, a 4.5-inch glass fiber dome midrange 31 [Scanspeak, 12W/8524G00], a 1-inch beryllium tweeter 32 [Scanspeak, D3004/6040-10], a 3-inch silk dome midrange 33 [Scanspeak, D7608/920010], and a 6-inch leather synthetic midrange/woofer 34 [Sonodyne, Hummer625] are sequentially arranged from the upper end on the left side.

In contrast, a 4.5-inch glass fiber dome midrange 35 [Scanspeak, 12W/8524G00], an aluminum ribbon tweeter 36 [Aurumcantus, G2], and an 11-inch paper cone woofer 37 [Eton, 11-612/C8/50] are sequentially arranged on the right side.

Here, the crossover of the left speaker has a range of 500 Hz to 1,000 Hz and 2 kHz to 4 kHz, more specifically a range of 650 Hz to 850 Hz and 2.5 kHz to 3.5 kHz, while the crossover of the right speaker has a range of 1 kHz to 3 kHz, more specifically a range of 1.5 kHz to 2.5 kHz.

The present invention is not limited to these embodiments. For example, the present invention may be applied to various sound devices such as a multi-channel speaker system for a home theater in addition to a soundbar, an earphone, a headphone, and a mobile phone speaker.

The present invention has an effect of improving a sense of presence of a stereo sound field by asymmetrically arranging a plurality of speaker driver units and emitting different tones.

This effect may be applied not only to a stereo speaker system but also to various sound devices such as multi-channel speaker systems including a soundbar, an earphone, and a headphone.

What is claimed is:

1. A speaker system comprising:
an individual enclosure having the same size to provide a sense of stereo sound; and
two or more speaker driver units arranged inside the enclosure, having different sizes, and formed of different materials,
wherein the separated units are asymmetrically configured between individual speakers.

2. The speaker system of claim 1, wherein the numbers of driver units in the individual speakers are asymmetrically configured.

3. The speaker system of claim 1, wherein one speaker and the other speaker are asymmetrically configured such that the one speaker emphasizes a middle-high frequency range and the other speaker emphasizes a low frequency range.

4. The speaker system of claim 1, wherein the number of crossover frequencies asymmetrically differs between the individual speakers.

5. The speaker system of claim 1, wherein resonant frequencies of tweeters arranged in the individual speakers asymmetrically differ from each other.

6. The speaker system of claim 1, wherein the individual speakers are asymmetrically configured to have no woofer driver unit or no mid-range driver unit.
